(19) United States
(12) Patent Application Publication
(10) Pub. No.: US 2024/0297326 A1
(43) Pub. Date: Sep. 5, 2024

(54) ENERGY PRODUCTION SYSTEM

(71) Applicant: PHOTONCYCLE AS, Oslo (NO)

(72) Inventors: Bjørn Brandtzæg, Oslo (NO); Einar Vøllestad, Oslo (NO)

(73) Assignee: PHOTONCYCLE AS, Oslo (NO)

(21) Appl. No.: 18/573,676

(22) PCT Filed: Jun. 28, 2022
(86) PCT No.: PCT/EP2022/067762

§ 371 Date: Dec. 22, 2023

(30) Foreign Application Priority Data
Jun. 28, 2021 (EP) 21182145.9

(51) Int. Cl. H01M 8/22; B01D 53/02; B01J 23/02; B01J 23/58; B01J 23/745; C01C 1/00; C01C 1/02; C01C 1/04; C25B 1/04; C25B 9/67; C25B 15/08; H01M 8/04082; H01M 8/04537; H01M 8/04858; H01M 8/0656; H01M 8/0662; H01M 8/12; H01M 8/18

(52) U.S. Cl. CPC H01M 8/222; B01D 53/02; B01J 23/02; B01J 23/58; B01J 23/745; C01C 1/006; C01C 1/024; C01C 1/0411; C25B 1/04; C25B 9/67; C25B 15/081; H01M 8/04216; H01M 8/04604; H01M 8/04925; H01M 8/0656; H01M 8/0662; H01M 8/12; H01M 8/186; B01D 2257/102; B01D 2257/108; H01M 2008/1293; H01M 2250/10; H01M 2250/405

(57) ABSTRACT

The present invention provides a decentralized and compact energy production system utilising ammonia for storage-of electric power and ammonia or H₂ for production of electric power and heat suitable for use by a single household or in a small commercial building.

### FIELD OF THE INVENTION

The present invention provides a decentralized and compact energy production system utilising ammonia for storage-of electric power and ammonia or H₂ for production of electric power and heat and adapted for use by a single household or in a small commercial building.

### BACKGROUND

The grid must phase out electricity and heat generated from fossil fuels to reduce greenhouse gas emissions. This may be achieved by phasing in intermittent electric power from wind-and solar PV (photovoltaics) modules. The use of intermittent power will require increased system reserve capacity to balance electricity supply and electricity demand in real time. Batteries can deal with the hourly intermittency challenge. However, currently the energy storage density of a battery is low, and the cost of manufacturing per kWh of storage capacity is high and despite technical innovations, it is unlikely that compact batteries that can store large quantities of electricity will emerge in the coming decades.

There is a significant seasonal mismatch between supply and demand for electricity from rooftop solar PV modules in temperate climates that uses electricity for heating. Generation of power mainly takes place during the late spring, summer and early autumn while electricity demand including for heating mainly is in the autumn, winter and spring.

With a large solar PV module system without a battery, generating 20,000 kWh per year, which fully can meet electricity demand in a household on an annual basis, depending on the latitude, as little as 30% of the electricity produced is consumed in the household and the balance exported to the electrical grid. A corresponding amount of electricity has to be imported from the grid to balance household supply and demand. With a 14 kW battery, the system is able to shift demand and supply during a 24 hour period, enabling the utilisation of approximately 50% of generated electricity. However, for the house which consumes 20,000 kWh annually of heat and electricity to be able to fully utilise the electricity it is producing, seasonal storage of up to 10,000 kWh is required.

Large quantities of PV electricity can be stored as hydrogen (H₂) or hydrogen containing chemicals. However, hydrogen is challenging to store in large quantities, as it becomes a liquid at −253° C. Hydrogen is also highly explosive, thus making it unsuitable for use as a storage medium for household purposes or in small commercial buildings.

Ammonia is an effective hydrogen carrier, and it is easier to store in large quantities as it becomes a liquid at −33° C. or at 10 bar pressure.

Currently, a typical large centralized ammonium synthesis plant operates around 400-500° C. and 100 bar-150 bar. However, for an ammonia synthesis reactor to be suitable for use in a decentralized small-scale energy production system the production of ammonia has to take place at 1-30 bar pressure to reduce energy and space requirements in production, noise and alleviate safety concerns.

A large scale centralized energy production systems for production and storage of electric power utilizing ammonia is relatively energy inefficient as that excess heat generated in the system during the various process steps are lost when transported in pipes over long distances and it is challenging to utilize even excess heat that is captured efficiently. Thus, making large centralized energy production systems for production and storage of electric power utilizing ammonia is potentially less energy efficient than a decentralised system where heat from the production process of ammonia and electricity can be captured and utilized efficiently through a water based heating system.

Mukelabai, M. D. et al., A novel integration of a green power-to-ammonia to power system: Reversible solid oxide fuel cell for hydrogen and power production coupled with an ammonia synthesis unit, March 2021, Journal of hydrogen energy, vol. 46, pp. 18546-18556, discuss the importance for a power-to-ammonia to power system to tackle intermittency and suggests to use a nitrogen-rich fuel electrode exhaust gas for ammonia synthesis during fuel cell mode. However, the system disclosed in Mukelabai, M. D. et al. is designed to deliver around 3 MW. To deliver such a system, the system comprises a H₂ five-stage compressor and H2 compression storage buffer tank and utilizes the Haber Bosch process for ammonia synthesis.

The present invention has as its objects to design a compact decentralized energy production system utilising ammonia for storage-and ammonia and/or hydrogen for production of electric power that is adapted for use by a single household or in a small commercial building. The system produces electricity in the range from 10 kW to 40 KW preferably around 30 kW per hour in power production mode. The system of the present invention also capture the excess heat in the production process to meet the heating requirements in a household which enables an efficient decentralised renewable energy system. The system of the present invention has the advantage that it can quickly switch between ammonia synthesis mode, i.e. power storage mode and power production mode.

### SUMMARY OF THE INVENTION

In a first aspect an energy production system utilising ammonia for storage-and production of electric power, said system comprising:
a reversible electrochemical cell system adapted for production of hydrogen from electric power in electrolysis mode when the energy production system runs in electric power storage mode and production of electric power from ammonia in fuel-cell mode when the production system runs in electric power production mode;
an air separator adapted to achieve at least 96% pure nitrogen, wherein the air separator is arranged to provide nitrogen to the ammonia synthesis reactor when the energy production system 1 runs in electric power storage mode;
an ammonia synthesis reactor comprising a catalyst, wherein the synthesis reactor is arranged to receive hydrogen from the reversible electrochemical cell system and nitrogen from the air separator when the energy production system runs in electric power storage mode;
an ammonia separation reactor comprising solid absorbent material which separates ammonia from N₂ and H₂ and adapted for receiving ammonia, and unreacted N₂ and H₂ from the ammonia synthesis reactor and providing ammonia to an ammonia storage unit when the energy production system runs in electric power storage mode and;
an ammonia storage unit comprising a metal halide adapted to store ammonia wherein the ammonia storage unit is arranged to receive ammonia from the ammonia synthesis reactor and/or the ammonia separation reactor when the energy production system runs in electric power storage mode and arranged to provide ammonia to the reversible electrochemical cell system when the energy production system runs in electric power production mode;
   a heat transfer system comprising at least one heat exchanger adapted to transfer heat generated in the energy production system. In a second aspect an energy production system utilising ammonia for storage-and hydrogen for production of electric power, said system comprising:
a reversible electrochemical cell system adapted for production of hydrogen from electric power in an electrolysis mode when the energy production system runs in electric power storage mode and production of electric power from hydrogen in fuel-cell mode when the production system runs in electric power production mode;
an air separator adapted to achieve at least 96% pure N₂, wherein the air separator is arranged to provide N₂ to the ammonia synthesis reactor when the energy production system runs in electric power storage mode;
an ammonia synthesis-and ammonia cracker reactor comprising a catalyst, wherein the synthesis reactor is arranged to receive H₂ from the reversible electrochemical cell system and N₂ from the air separator when the energy production system runs in electric power storage mode;
an ammonia separation reactor comprising a solid absorbent material which separates ammonia from N₂ and H₂ and adapted for receiving ammonia, and unreacted N₂ and H₂ from the ammonia synthesis-and ammonia cracker reactor and providing ammonia to an ammonia storage unit when the energy production system runs in electric power storage mode and;
an ammonia storage unit comprising a metal halide adapted to store ammonia wherein the ammonia storage unit is arranged to receive ammonia from the ammonia synthesis-and ammonia cracker reactor and/or the ammonia separation reactor when the energy production system runs in electric power storage mode and arranged to provide ammonia to the ammonia synthesis-and ammonia cracker reactor when the energy production system runs in electric power production mode;
a heat transfer system comprising at least one heat exchanger adapted to transfer heat generated in the energy production system.

In one embodiment according to the first or the second aspect the reversible electrochemical cell system operates in a temperature range from 400° C. to 800° C.

In one embodiment according to the first or the second aspect the electrochemical cell system operates a temperature from 400° C. to 600° C.

In one embodiment according to the first or the second aspect the electrochemical cell system operates a temperature from 550° C. to 750° C.

In one embodiment according to the first or the second aspect the electrochemical cell system operates a temperature from 550° C. to 850° C.

In one further embodiment according to the first or the second aspect the electrochemical cell system operates a temperature from 600° C. to 850° C.

In one further embodiment according to the first or the second aspect the electrochemical cell system operates a temperature from 700° C. to 850° C.

In one further embodiment the electrochemical cell system operates a temperature from 700° C. to 800° C.

Preferably the electrochemical cell system operates a temperature from 550° C. to 750° C.

The reversible electrochemical cell system adapted to run at low temperature, i.e. at a temperature below 850° C. and preferably at a temperature in the range from 550° C. to 750° C. in order to be able to quickly to ramp the energy system up and down 5 depending on energy production need.

In one embodiment according to the second aspect the reversible electrochemical cell system of the energy production system is adapted to tolerate impurities in the H2 gas stream provided from the ammonia cracker when the system runs in electric power production mode.

In one embodiment according to the second aspect the reversible electrochemical cell system of the energy production system is adapted to tolerate at least 0.15% ammonia in the H2 gas stream such as from 0.05% to 1% ammonia.

The reversible electrochemical cell system is adapted to tolerate NH3 impurities in order to prevent the need of extra purification units to clean the H2 gas provided from the ammonia cracker.

In one embodiment according to the first or the second aspect the electrochemical cell system operates at a pressure from 1 bar to 30 bar.

In one embodiment according to the first or the second aspect the electrochemical cell system operates at a pressure from 1 bar to 20 bar.

In one embodiment according to the first or the second aspect the electrochemical cell system operates at a pressure from 1 bar to 10 bar.

In one embodiment according to the first or the second aspect the electrochemical cell system operates at a pressure from 1 bar to 5 bar.

In one embodiment according to the first or the second aspect the electrochemical cell system operates at a pressure from 3 bar to 5 bar to 15 bar.

In one embodiment according to the first or the second aspect the electrochemical cell system operates at a pressure from 15 bar to 30 bar.

In one embodiment according to the first or the second aspect the reversible electrochemical cell system is a reversible solid oxide cell.

Preferably the reversible electrochemical cell system is a reversible solid oxide cell.

In one embodiment according to the first or the second aspect the cell material of the reversible solid oxide cell is a metal or ceramic supported cell.

In one embodiment according to the first or the second aspect the reversible electrochemical cell system is connected to or comprises a reactor for hydrogen separation and compression and arranged to provide hydrogen to the ammonia synthesis reactor wherein the energy production system is adapted for production of ammonia in electric power storage mode.

In one embodiment according to the first or the second aspect the reactor for hydrogen separation and compression is a high-temperature electrochemical hydrogen pump.

In one embodiment according to the first or the second aspect the reactor for hydrogen separation and compression is adapted to run at a temperature from about 400° C. to about 800° C.

In one embodiment according to the first or the second aspect the reactor for hydrogen separation and compression operates a temperature from 400° C. to 600° C.

In one embodiment according to the first or the second aspect the reactor for hydrogen separation and compression operates a temperature from 550° C. to 750° C.

In one embodiment according to the first or the second aspect the reactor for hydrogen separation and compression operates a temperature from 550° C. to 850° C.

In one further embodiment according to the first or the second aspect the reactor for hydrogen separation and compression operates a temperature from 600° C. to 850° C.

In one further embodiment according to the first or the second aspect reactor for hydrogen separation and compression operates a temperature from 700° C. to 850° C.

In one further embodiment according to the first or the second aspect the reactor for hydrogen separation and compression operates a temperature from 700° C. to 800° C.

In one embodiment according to the first or the second aspect the separation and compression reactor, may be a high-temperature electrochemical hydrogen pump based on Protonic Membrane Reactor.

In one embodiment according to the first or the second aspect the separation and compression reactor may produce heat during separation and compression of hydrogen.

In one embodiment according to the first or the second aspect the separation and compression reactor may be a reactor able to separate and compress hydrogen electrochemically at low noise.

In one embodiment according to the first or the second aspect the air separator is adapted to achieve at least 96% such as at least 97% or 98% pure N2.

In one embodiment according to the first or the second aspect the air separator is adapted to achieve at least 99%, 99.5%, 99.6%, 99.7%, 99.8% or at least 99.9% pure N2.

In one embodiment according to the first or the second aspect the air separator is operating at a at a pressure from 1 bar to 20 bar.

In one embodiment according to the first or the second aspect the air separator is operating at a at a pressure from 3 bar to 18 bar.

In one embodiment according to the first or the second aspect the air separator is operating at a at a pressure from 3 bar to 15 bar.

In one embodiment according to the first or the second aspect the air separator is operating at a at a pressure from 3 bar to 10 bar.

In one embodiment according to the first or the second aspect the air separator is a cryogenic distillation unit, a pressure swing adsorption (PSA) unit or a membrane unit.

In one embodiment according to the first or the second aspect the air separator is a pressure swing adsorption unit.

In one preferred embodiment according to the first or the second aspect, the air separator is a PSA unit or a membrane unit and more preferably a PSA unit.

In one embodiment according to the first aspect or the second aspect the ammonia synthesis reactor is adapted to operate at a low temperature, which is a temperature in the range from about 250° C. to about 500° C.

In one embodiment according to the first aspect or the second aspect the ammonia synthesis reactor is adapted to operate at a low temperature, which is a temperature in the range from about 350° C. to about 500° C.

In a preferred embodiment the ammonia synthesis reactor is adapted to operate at a temperature in the range from about 350° C. to about 500° C.

In one embodiment according to the first aspect or the second aspect the ammonia synthesis reactor is adapted to operate at pressure of about 3 MPa or lower.

In one embodiment according to the first aspect or the second aspect the ammonia synthesis reactor is adapted to operate at pressure from MPa 3 to 1 MPa.

In one embodiment according to the first aspect or the second aspect the ammonia synthesis is adapted to operate at pressure from 2 MPa to 1 MPa.

In one embodiment according to the first aspect or the second aspect the ammonia synthesis reactor is adapted to operate at pressure from 1.5 MPa to 0.5 MPa.

In one embodiment according to the first aspect or the second aspect the ammonia synthesis is adapted to operate at pressure around 1 MPa.

In one preferred embodiment the according to the first aspect or the second aspect the ammonia synthesis reactor is adapted to operate at pressure around 1.5 MPa or lower.

The low pressure, i.e. a pressure around 3 MPa or lower of the ammonia synthesis reactor is an advantage of the system in order to reduce the noise of the system down to 70 db to 10 db, such as from 40 db to 30 db, which is comparable to the noise from a refrigerator. In one embodiment the catalyst of the ammonia synthesis reactor of the first and the second aspect and the catalyst of the reversible process of the cracker of the second aspect is selected from Fe-based catalyst, Ru-based catalyst, ceramic mixed oxide-based catalyst, or promoted metal catalyst on a reducible or partially reducible mixed oxide support material.

In one embodiment the catalyst of the ammonia synthesis reactor and the ammonia cracker according to the first aspect or the second aspect is selected from hydrides, nitrides and trimetallic compounds.

In one preferred embodiment the catalyst of the ammonia synthesis reactor and the ammonia cracker according to the first aspect or the second aspect is a promoted metal catalyst on a reducible or partially reducible mixed oxide support material.

In one preferred embodiment the catalyst of the ammonia synthesis reactor and the ammonia cracker according of the first aspect or the second aspect is a promoted metal catalyst on a reducible or partially reducible mixed oxide support material wherein the support material is selected from Mg. Ce and La or a combination

A further advantage of the present energy production system is that the catalyst of the ammonia synthesis reactor according to the first aspect or the second aspect is adapted to tolerate impurities in the H2 gas stream from the reversible electrochemical cell system of the energy production system thus overcome the need for a separate expensive and large purification unit for purification of the H2 gas stream thus enabling to provide a compact system.

In one embodiment the ammonia synthesis reactor according to the first aspect or the second aspect is adapted to operate at a pressure-times (*)-volume of 3 MPa*litre or lower, preferably about 2.5 MPa*litre or lower.

In one embodiment according to the second aspect the ammonia cracker which is the reversible process of the NH3 synthesis operates under a pressure 1 MPa or lower, such as 0.5 MPa or lower,

In one embodiment according to the second aspect the ammonia cracker operates at a temperature range from about 700° C. to about 400° C. such as from about 6500° C. to about 450° C., preferably from about 600° C. to about 450° C.

In one embodiment according to the first aspect or the second aspect the ammonia storage unit is connected to or comprises at least one ammonia separation reactor comprising an ammonia separation material.

In one embodiment according to the first aspect or the second aspect the system includes a recirculation pump that is adapted to pump unreacted H2 and N2 and unabsorbed NH3 back into the ammonia synthesis reactor from the ammonia separator.

The pump according to the above embodiment is adapted to recycle the H2 and N2 and unabsorbed NH3 back into the ammonia synthesis reactor from the ammonia separator in order for the system to convert sufficient amount of H2 and N2 to liquid NH3 to be separated and stored in metal halides.

In one embodiment according to the first aspect or the second aspect metal halide of the ammonia storage unit has the general formula MaXz, wherein M is a cation selected from Mn and Mg. X is an anion selected from chloride and bromide, a is the number of cations per salt molecule, z is the number of anions per salt molecule.

In one embodiment according to the first aspect or the second aspect the ammonia storage unit comprises the ammonia separation reactor.

In one embodiment according to the first aspect or the second aspect the ammonia separation material is a metal halide.

In one embodiment according to the first aspect or the second aspect metal halide of the ammonia separation reactor has the general formula MaXz, wherein M is a cation selected from Mn and Mg. X is an anion selected from chloride and bromide, a is the number of cations per salt molecule, z is the number of anions per salt molecule.

In one embodiment according to the first aspect or the second aspect said metal halide of the ammonia separation reactor is supported by a substrate selected from alumina, silica or zeolite.

In one embodiment according to the first aspect or the second aspect the system comprises a central system controller and a sensor wherein the central system controller is adapted to receiving that a current power production is either above or below a power production threshold; and transmitting a signal from the central system controller to cause the energy production system to switch to energy storage mode in which the reversible electrochemical cell system operates in electrolysis mode in the event that the power production rate is above the power production threshold; or to cause the energy production system to switch to an energy production mode in which the reversible electrochemical cell system operates in fuel-cell mode in the event that the power production is below the power production threshold.

In one embodiment the heat transfer system comprising at least one heat exchanger adapted to transfer heat generated by one or more of a unit of the energy production system in order to capture and provide heat to a water-based heating system in a household or a small commercial building.

In one embodiment the heat transfer system comprising at least one heat exchangers adapted to transfer heat between at least two separate units of the energy production system.

In one embodiment the reversible electrochemical cell system is connected to a heat exchanger in order to capture and provide heat to a water-based heating system in a household or a small commercial building.

In one embodiment the heat transfer system comprising at least one heat exchanger adapted to transfer heat generated in the energy production system in order to capture and provide heat to a water-based heating system in a household or a small commercial building.

In one embodiment a heat exchanger is adapted to transfer heat between at least two separate units of the energy production system 1.

In one embodiment of the present invention the heat generated in the at least one of the ammonia synthesis reactor and/or the ammonia separation reactor may be transferred by a heat exchanger to the steam generator, when the energy production system is adapted for storage of electric power.

In one embodiment the reversible electrochemical cell system is connected to a heat exchanger in order to transfer heat to the ammonia storage unit, wherein the energy production system is adapted for production of electric power.

In one embodiment the reversible electrochemical cell system is connected to a heat exchanger in order to capture and provide heat to a water-based heating system in a household or a small commercial building.

In one embodiment the heat transfer system comprising at least one heat exchanger adapted to transfer heat generated in the energy production system in order to capture and provide heat to a water-based heating system in a household or a small commercial building.

In one embodiment, the energy production system comprises or is connected to an intermittent energy resource.

In one embodiment, the intermittent energy resource is selected from a solar panel, a wind turbine, a water turbine or any combinations thereof.

In one embodiment the electric power of the energy production system is generated from any one of solar panel, wind turbine, water turbine or any combination thereof.

In one embodiment the electric power of the energy production system is generated from a battery, such as a lithium battery.

In one embodiment excess electric power generated by the intermittent energy resource is stored in the energy production and storage system as NH3 in a metal halide.

In one embodiment when there is no energy production from the intermittent energy resource the energy production system delivers electric power by release of NH3 from the NH3 stored in metal halide storage unit.

In one embodiment the system is a compact system having dimensions from 10 cubic meter or less.

In one embodiment the total dimension of the energy production system is about 10 m3 or less.

In one embodiment the total dimension of the energy production system is from 10 m3 to 4 m3.

In one embodiment the total dimension the energy production system is from 8 m3 to 4.5 m3.

In one embodiment the total dimension the energy production system is about 5 m3 wherein the ammonia storage unit 8 is about 3 m3.

In one embodiment the noise of the energy production system according to the invention is from 70 db to 10 db, such as from 40 db to 30 db, which is comparable to the noise from a refrigerator.

In one embodiment the system is for storage-or production of electric energy in a household or a small commercial building.

In one embodiment the system is coupled to an electrical grid.

In one embodiment the system is not coupled to an electrical grid.

In a third aspect the invention provides use of the energy production system according to the first or the second aspect or any embodiments therein, for storage-or production of electric energy in a household or a small commercial building.

In a fourth aspect the invention provides use of heat generated by the energy production system according to the first or the second aspects or any embodiments therein, in water-based heating systems in a household or a small commercial building, wherein the water-based heating systems comprises at least one of a radiator, a floor heating system, a hot water tank or any combinations thereof.

In a fifth aspect the invention provides a method of operating the energy production system according the first or the second aspects and any embodiments therein, comprising a central system controller, the method comprising:
a. receiving at the central system controller that a current power production is either above or below a power production threshold; and
b. transmitting a signal from the central system controller to cause the energy production system to switch to energy storage mode in which reversible electrochemical cell operates in electrolysis mode in the event that the power production rate is above the power production threshold; or to cause the energy production system to switch to an energy production mode in which the reversible electrochemical cell operates in fuel-cell mode in the event that the power production is below the power production threshold.

### BRIEF DESCRIPTION OF DRAWINGS

FIG. 1: A simple schematic illustration of an example embodiment of an energy production system according to the first or the second aspect utilizing a combination of solar panels, batteries, reversible electrochemical cells and ammonia-synthesis and storage, wherein the system is utilizing ammonia for storage of electric power and ammonia or H2 for the production of electric power. The system being particularly adapted for use by a single household or in a small commercial building.

FIG. 2: A detailed illustration of one embodiment of an energy production system. The figure illustrates the system design with flow directions for energy storage mode.

FIG. 3: A detailed illustration of one embodiment of an energy production system according to the first aspect. The figure illustrates the system design with flow directions for energy production mode.

### DETAILED DESCRIPTION

In the following description, various examples and embodiments of the invention are set forth in order to provide the skilled person with a more thorough understanding of the invention. The specific details described in the context of the various embodiments and with reference to the attached drawings are not intended to be construed as limitations.

Where a numeric limit or range is stated, the endpoints are included. Also, all values and subs range within a numerical limit or range are specifically included as if explicitly written out.

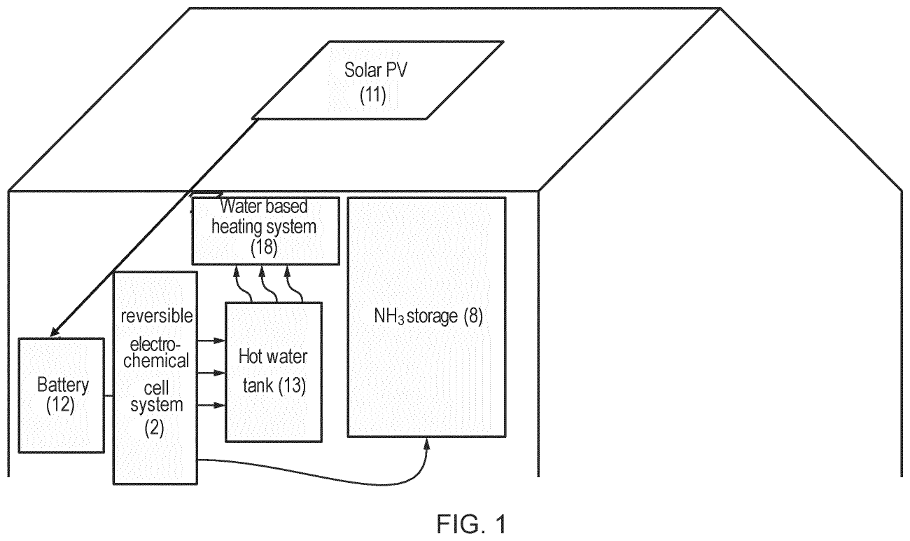

FIG. 1 illustrates the use of an energy production system according to the invention in a single household or in a small commercial building. The energy production system utilizes ammonia for storage-and production of electric power.

With reference to FIG. 1, the energy production system comprises a reversible electrochemical cell system 2 adapted for production of hydrogen from electric power in electrolysis mode when the energy production system 1 runs in electric power storage mode and production of electric power from ammonia in fuel-cell mode when the production system runs in electric power production mode.

The electric power is provided to the reversible electrochemical cell system 2 of the energy production system by a battery 12 and/or solar PV modules 11. Additionally. or alternatively, electric power is provided to the energy production system 1 by a wind turbine or water turbine. The solar PV modules are connected to the battery 12.

The energy production system comprises in addition an ammonia storage unit 8 adapted to store ammonia when the energy production system runs in electric power storage mode and arranged to provide ammonia to the reversible electrochemical cell system 2 when the energy production system 1 runs in electric power production mode.

One of the advantages of the present energy production system is that the system comprises at least one heat exchanger adapted to transfer heat generated in the energy production system in order to capture and provide heat to a water-based heating system in a household or a small commercial building.

As illustrated in FIG. 1 excess heat generated in the reversible electrochemical cell system 2 is adapted to provide heat to a hot water tank 13 wherein the hot water tank 13 may be adapted to provide hot water to a water-based heating system 18.

The energy production system according to the present invention is a compact, decentralized system that is located in a single building and serves the purpose of providing production and storage of power for the building it is located within or in close proximity to. A building being a private home, a holiday house, a cottage, or a small commercial building.

The energy production system 1 according to the invention may be connected to an electrical grid.

The energy production system 1 according to the invention may be an off-grid system, i.e. not part of an electrical grid.

The energy production system according to the invention is a compact system, i.e. the energy production system 1 must be compact in order for it to be suitable for use by a single household or in a small commercial building.

The total dimension of the compact energy production system may be no more than 10 cubic meters.

The compact energy production system according to the first or second aspect is a system that

To reduce noise and energy requirements in the energy production system according to the invention, the process for production of ammonia in the ammonia synthesis reactor 6 during electrical storage mode may operate at a pressure of 3 MPa preferably at 1.5 MPa or lower, unlike most ammonia production processes that runs at typically 10 to 15 MPa. The reduction in pressure is necessary in order to reduce noise.

The system according to the invention is adapted to balance cost and flexibility, while still ensuring efficient energy harvesting and reliable power supply during peak hours.

The energy production system according to the invention is a dynamic system that can easily switch between electric power storage mode and electric power production mode and comprises in certain embodiments a central system controller and a sensor wherein the central system controller is adapted to receiving from the sensor that a current power production is either above or below a power production threshold; and transmitting a signal from the central system controller to cause the energy production system to switch to energy storage mode in which the reversible electrochemical cell system operates in electrolysis mode in the event that the power production rate is above the power production threshold; or to cause the energy production system to switch to an energy production mode in which the reversible electrochemical cell system operates in fuel-cell mode in the event that the power production is below the power production threshold.

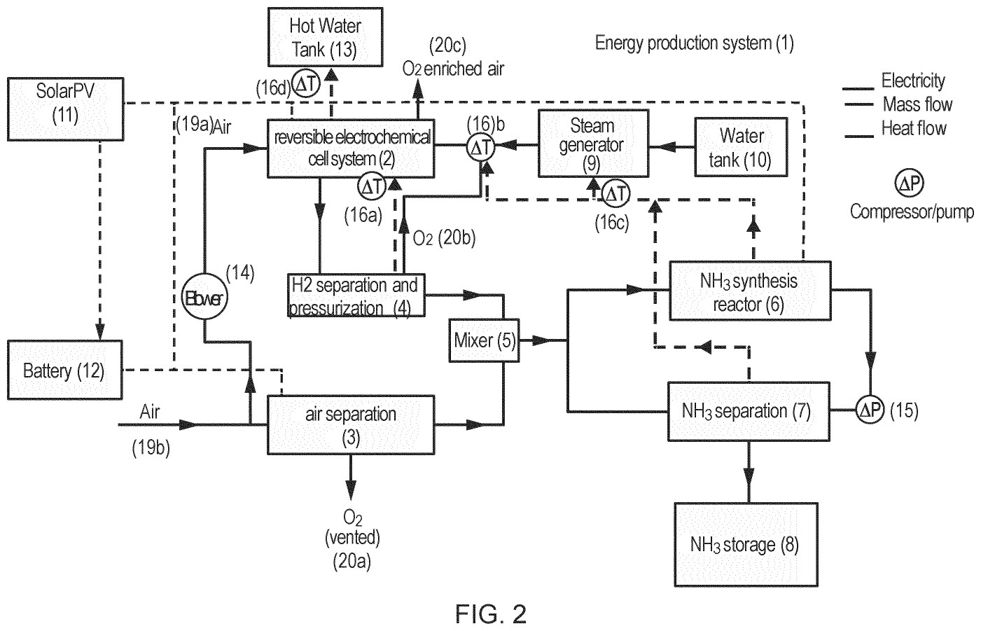

A detailed description of an embodiment of the energy production system according to the invention is shown in FIG. 2.

The system in FIG. 2 is run in electric power storage mode. The arrows indicate the direction in which electric power is transferred, as well as the mass and heat flows.

The energy production system 1 may comprise:
a reversible electrochemical cell system 2 adapted for production of hydrogen from electric power in electrolysis mode;
an air separator 3 adapted to achieve clean N2 to an ammonia synthesis reactor 6;
an ammonia synthesis reactor 6 comprising a catalyst, wherein the synthesis reactor is arranged to receive H2 from the reversible electrochemical cell system 2 and N2 from the air separator 3;
an ammonia separation reactor 7 comprising an ammonia separation material which separates ammonia from N2 and H2 and adapted for receiving ammonia, and unreacted N2 and H2 from the ammonia synthesis reactor 6 and providing ammonia to the ammonia storage unit 8;
an ammonia storage unit 8 comprising a metal halide adapted to store ammonia wherein the ammonia storage unit is arranged to receive ammonia from the ammonia synthesis reactor 6 and/or the ammonia separation rector 7; and
a heat transfer system comprising at least one heat exchanger 16, a, b, c, d, e, f, g adapted to transfer heat generated in the energy production system 1.

Alternatively, the energy production system may comprise:
a reversible electrochemical cell system 2 adapted for production of hydrogen from electric power in electrolysis mode;
an air separator 3 adapted to achieve clean N2 to an ammonia synthesis reactor 6;
an ammonia synthesis-and cracker reactor comprising a catalyst, wherein the synthesis reactor is arranged to receive H2 from the reversible electrochemical cell system 2 and N2 from the air separator 3;
an ammonia separation reactor 7 comprising an ammonia separation material which separates ammonia from N2 and H2 and adapted for receiving ammonia, and unreacted N2 and H2 from an ammonia synthesis-and cracker reactor and providing ammonia to an ammonia storage unit 8;
an ammonia storage unit 8 comprising a metal halide adapted to store ammonia wherein the ammonia storage unit is arranged to receive ammonia from the ammonia synthesis-and cracker reactor and/or the ammonia separation rector 7; and
a heat transfer system comprising at least one heat exchanger 16, a, b, c, d, e, f, g adapted to transfer heat generated in the energy production system 1.

The energy production system 1 may comprising or may be connected to an intermittent energy resource.

The intermittent energy resource is selected from a solar PV module, wind turbine and/or water turbine.

The energy production system 1 may is connected to a battery.

In electric power storage mode power generated by the rooftop solar PV modules 11 or alternatively wind-or water turbines are stored in a battery 12 or directly provided into the reversible electrochemical cell system 2.

The reversible electrochemical cell system 2 requires electrical power to drive the non-spontaneous production of hydrogen.

The reversible electrochemical cell system 2 operates in a temperature range from 400° C. to 800° C. such as from 400° C. to 700° C. and preferably from 550° C. to 750° C. and is adapted for production of hydrogen (H₂) and heat from electric power in electrolysis mode.

The reversible electrochemical cell system 2 is an electrochemical cell system that is able to use electrical power to cause a chemical reaction in electrolysis mode and in the reversible process to generate electrical power from a chemical reaction in fuel cell mode.

In the electrolysis mode the reversible electrochemical cell system 2 use electrical power to produce hydrogen and oxygen from water, wherein the water is in form of steam generated by a steam generator 9, wherein the steam is provided to the electrochemical cell system 2 by a water tank 10 and a steam generator 9 wherein the water tank is connected to the steam generator which is further connected to the electrochemical cell system.

During electrolysis of water, air 19a is provided into the electrochemical cell system 2 by blower 14. The air is supplied into the cell in close proximity to where oxygen is produced in order to help remove the oxygen quickly. An outlet 20c vents out “O2-enriched” air. Thus, the purpose of the air is as a “carrier gas” for the produced oxygen. enriched”.

The reversible electrochemical cell system 2 may be connected to a hot water tank 13 whereby the electrochemical cell system 2 is adapted to transfer heat generated during electrolysis mode to the water tank 13 by heat exchanger 16d.

During electrolysis mode the electrochemical cell system 2 may be adapted to receive heat from the hydrogen separation and compression reactor 4 by transfer of heat by heat exchanger 16a.

During electrolysis mode the steam generator 9 may be adapted to receive heat from the exothermal synthesis reaction of ammonia in the ammonia synthesis reactor 6 by transfer of heat by heat exchanger 16b, c.

During electrolysis mode the steam generator 9 may be adapted to receive heat from the ammonia separation reactor 7 by transfer of heat by heat exchanger 16b, c.

The reversible electrochemical cell system may be connected to a hydrogen separation and compression reactor 4 in order for providing clean hydrogen into the mixer 5.

Alternatively, the reversible electrochemical cell system 2 may comprise the reactor 4 for separation and compression of H2.

The reversible electrochemical cell system 2 may be a reversible solid oxide electrochemical cell (SOEC) comprising a reactor 4 for separation and compression of H2.

Alternatively, the reversible electrochemical cell system 2 may be a reversible solid oxide fuel cell (SOFC).

During electrolysis mode and storage of electrical power the air separator 3 is adapted to receive air 19b into the air separation unit and further adapted to separate nitrogen out of the air 19b. The air separator 3 is connected to a mixer 5 and adapted to transfer N2 to the mixer 5. Oxygen 20a is vented out of the air separator. During electrolysis mode the air separator 3 may be adapted to receive electricity from battery 12.

During electrolysis mode the air separator 3 may be adapted to receive electricity from solar PV module 11.

The mixer 5 is connected to the ammonia synthesis reactor 6 and adapted for delivering H2 and N2 to the ammonia synthesis reactor 6.

The ammonia synthesis reactor 6 or the ammonia synthesis-and cracker reactor is connected to a compressor or pump 15 that transfers ammonia and unreacted hydrogen and nitrogen to a separation reactor 7 which is adapted to separate out ammonia. Ammonia from the separation reactor 7 is transferred to the ammonia storage unit 8. Unreacted nitrogen and hydrogen from the separation reactor 7 is circulated back to the ammonia synthesis reactor 6.

During electrolysis mode the ammonia synthesis reactor 6 or the ammonia synthesis-and cracker reactor may be adapted to receive electricity from battery 12.

During electrolysis mode the ammonia synthesis reactor 6 may be adapted to receive electricity from solar PV module 11.

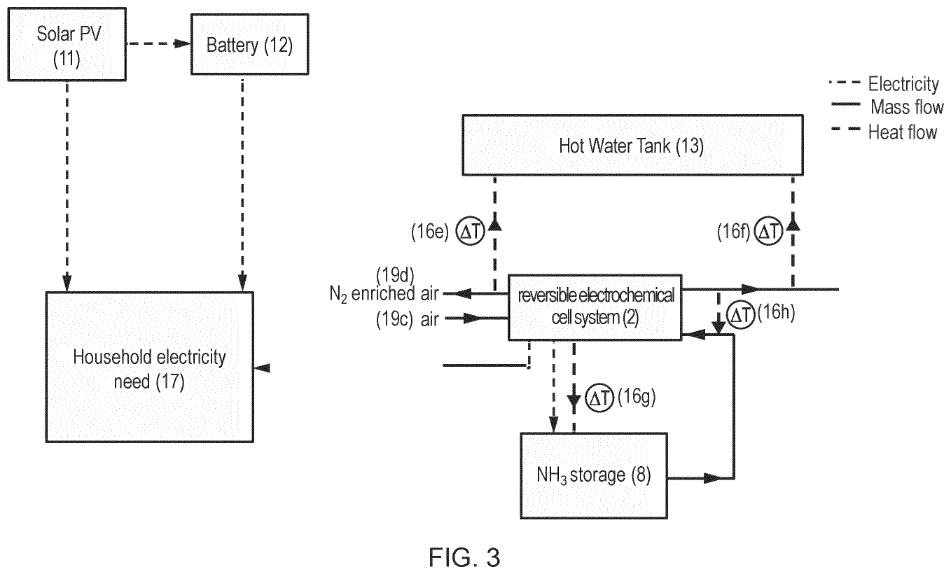

A detailed description of an embodiment of the energy production system according to the invention is shown in FIG. 3.

The system in FIG. 3 is run in electric power production mode. The arrows indicate the direction in which electric power is transferred, as well as the mass and heat flows

During power production mode the reversible electrochemical cell system 2 is run in fuel cell mode.

In fuel cell mode according to the first aspect of the present invention the ammonia storage unit 8 is adapted to deliver ammonia to the reversible electrochemical cell system 2 that decompose ammonia into nitrogen and hydrogen.

During fuel cell mode air is entering the fuel cell via air inlet 19c in order to supply oxygen as a reactant. Oxygen is transported through the fuel cell to react with hydrogen and thus generate heat and electricity. “N2-enriched” air leaves the fuel cell via outlet 19d.

In fuel cell mode excess heat generated by the reversible electrochemical cell system 2 may be transferred to a hot water tank by a heat exchanger 16e and/or 16f.

In fuel cell mode excess heat generated by the reversible electrochemical cell system 2 may be transferred to the ammonia storage unit by a heat exchanger 16g.

In fuel cell mode the decomposition of ammonia produces electric power that is transferred to the household electricity system 17 in need of electricity.

In fuel cell mode the decomposition of ammonia produces electric power that may be transferred to the ammonia storage unit 8.

In order to release ammonia from the ammonia storage unit 8 the ammonia storage unit requires heating.

Alternatively, according to the second aspect wherein the system comprises an ammonia synthesis-and cracker reactor, in fuel cell mode the ammonia storage unit 8 is adapted to deliver ammonia to the ammonia synthesis-and cracker reactor that decompose ammonia into nitrogen and hydrogen and wherein the hydrogen is transferred to the reversible electrochemical cell system 2 that runs in fuel cell mode to produce electrical power.

### The Electrochemical Cell System 2

A reversible electrochemical cell system is an electrochemical cell system that is able to use electrical power to cause a chemical reaction in electrolysis mode and in the reversible process to generate electrical power from a chemical reaction in fuel cell mode.

In the fuel cell mode, the electrochemical cell system 2 according to the first aspect of the present invention is a fuel cell adapted for operation on ammonia (NH3). The decomposition of ammonia is an endothermic reaction.

In the fuel cell mode, the electrochemical cell system 2 according to the second aspect of the present invention is a fuel cell adapted for operation on H2.

The reversible electrochemical cell system according to the first or the second aspect is an electrochemical cell that during electrolysis mode split water into hydrogen and oxygen requiring electrical power as the reaction is not spontaneous because the global reaction potential is negative.

Typically, electrochemical cell adapted for water electrolysis unit consists of an anode and a cathode separated with an electrolyte.

The electrolyte may be made of an aqueous solution containing ions, a proton exchange membrane (PEM) or an oxygen ion exchange ceramic membrane.

The reversible electrochemical cell system according to the first or the second aspect comprises more than one reversible electrochemical cell forming a stack of electrochemical cells.

The reversible electrochemical cell system according to the first or the second aspect is an electrochemical cell that operates at a temperature range from 400° C. to 850° C., preferably around 550° C. to 750° C. As a high temperature, such as temperatures above 400° C., is beneficial for decomposition of ammonia during fuel cell operation.

The reversible electrochemical cell system according to first or the second aspect is an electrochemical cell that operates at a temperature range from 400° C. to 850° C. preferably around 550° C. to 650° C. that decreases the electricity needed for the conversion of steam to hydrogen in electrolysis mode.

The electrochemical cell system 2 may operate a temperature that minimize the degradation of electrochemical cell material.

The cell of the electrochemical cell 2 according to the first aspect may be a metal or ceramic supported cell adapted to decompose ammonia into N2 and H2 at a temperature range from 400° C. to 850° C. when the electrochemical cell system 2 runs in fuel cell mode and adapted to decompose water into H2 and O2 during electrolysis mode.

The cell of the electrochemical cell 2 according to the second aspect may be a metal or ceramic supported cell adapted to utilize H2 to produce electrical power at a temperature range from 400° C. to 850° C. when the electrochemical cell system 2 runs in fuel cell mode and adapted to decompose water into H2 and O2 during electrolysis mode.

The electrochemical cell system according to the first or the second aspect may be adapted for operating at atmospheric pressure.

The electrochemical cell system according to the first or the second aspect may be adapted for operating at pressures above atmospheric pressure ranging from 1 bar to 30 bar.

The reversible electrochemical cell system 2 according to the first or the second aspect may be a reversible solid oxide fuel cell (SOFC).

SOFC is an electrochemical cell system that produces electricity directly from oxidizing a fuel such as NH3 in the first aspect. Fuel cells are characterized by their electrolyte material; the SOFC has a solid oxide or ceramic electrolyte.

SOFC is an electrochemical cell system that produces electricity directly from H2 according to the second aspect. Fuel cells are characterized by their electrolyte material; the SOFC has a solid oxide or ceramic electrolyte.

Alternatively, the reversible electrochemical cell system 2 is a reversible solid oxide electrolyser cell (SOEC).

The SOEC may operate in an exothermic mode to provide surplus heat.

Commercial SOEC and SOFC are available on the market.

TABLE 1
KPIs representative for commercial solid oxide cell
(SOC) stacks and systems. LHV = lower heating value.

| KPI | SOFC | SOEC |
|---|---|---|
| Electrical efficiency [%] (system) | 60.5 (LHV) | 80-100 (LHV)*1 |
| Total efficiency (incl. heat utilization) [%] | 90 | |
| Electrical power consumption [kWh/Nm3 H2] | | 3.0-3.7* |
| Degradation rate [%/1000 h] (stack) | 0.2-1.02 | 0.2-1.55 |
| Longest demonstrated operation [h] (stack) | 100 000 | 23 000** |
| Operating temperature [° C.] | 550-850 | |
| Operating pressure [bar] | 1-30 | |
| Volumetric power density [W/L] (system) | 2-10 | |
| Gravimetric power density [W/kg] (system) | 5-20 | |
| Volumetric power density [W/L] (stack) | 200-500 | |
| Gravimetric power density [W/kg] (stack) | 100-200 | |
| Noise [dB] (system) | <47 | |
| TRL (system) | 8 | 5/6 |

*Higher efficiency if water is supplied as steam, lower if supplied as liquid.
**SoA cells/stacks displaying sufficiently low degradation rates.

Example of commercial providers of SOC stacks: Ceres Power, Sunfire, SOLIDpower, Haldor Topsoe or Elcogen.

### Separation and Compression Reactor 4

The separation and compression reactor 4, may be a high-temperature membrane reactor.

The separation and compression reactor 4, may be a high-temperature electrochemical hydrogen pump.

The separation and compression reactor 4, may be a high-temperature electrochemical hydrogen pump based on Protonic Membrane Reactor.

The separation and compression reactor 4 may be a reactor able to separate and compress hydrogen electrochemically at low noise.

The separation and compression reactor 4 may produce heat during separation and compression of hydrogen.

The separation and compression reactor 4 may operate at a temperature from 500° C. to 800° C.

### Air Separator 3

The air separator rector 3 is an air separation reactor able to achieve high-purity nitrogen (N₂).

The air separator rector 3 may operating at low pressure.

The air separator rector 3 may be adapted to achieve at least 96% pure N₂ to the mixer 5.

The air separator rector 3 may be adapted to achieve at least 97% or 98% pure N₂ to the mixer 5.

The air separator rector 3 may be adapted to achieve at least 99%, 99.5%, 99.6%, 99.7%, 99.8% or at least 99.9% pure N₂ to the mixer 5.

The air separator may be a cryogenic distillation unit, a pressure swing adsorption (PSA) unit or a membrane unit. Preferably, the air separator is a PSA unit or a membrane unit. More preferably a PSA unit.

A person skilled in the art is aware of commercially available nitrogen air separators that is suitable for the use in the energy production system according to the present invention.

Example of a supplier of a cryogenic distillation separator is The Linde Group, Immatec, Compressed Gas Technology Inc, Air Products (PRISM3030)

### Ammonia Synthesis Reactor 6 and the Ammonia Synthesis-and Cracker Reactor

Ammonia is commercially produced by the Haber-Bosch process.

The process reaction is reversible, and the production of ammonia is exothermic.

$${N}_{2} + 3 {H}_{2} \to 2 {NH}_{3} Δ {H}^{o} = - 9 1.8 kJ / mol$$

The conventional Haber-Bosch process is typically conducted at pressures above 10 MPa/100 bar and between 400° C. to 500° C.

For a compact energy production system the ammonia synthesis reactor or a ammonia synthesis-and cracker reactor is adapted to operate at a low temperature, such as a temperature in the range from 250° C. to 550° C., such as in the range from 250° C. to 350° C. and preferably in the range from 350° C. to 500° C.

Further, the ammonia synthesis reactor or the ammonia synthesis-and cracker reactor is adapted to operate at pressure of 3 MPa or below preferably around 1.5 MPa or below.

The ammonia synthesis reactor or the ammonia synthesis-and cracker reactor may be operated under dynamic operating conditions.

The ammonia synthesis reactor or the ammonia synthesis-and cracker reactor may under conditions when storage of power is not required still be running at 10-20% of full capacity in order to decrease the time needed for ramping up the ammonia synthesis production.

The ammonia cracker may under the reversable process and in power production mode operate at a pressure 1 MPa or lower, such as 0.5 MPa or lower,

The ammonia cracker may under the reversable process and in power production mode operate at a temperature range from about 700° C. to about 400° C. such as from about 650° C. to about 450° C., preferably from about 600° C. to about 45° C.

A catalyst of ammonia synthesis reactor or the ammonia synthesis-and cracker reactor may be a Fe-based catalyst, Ru-based catalyst, ceramic mixed oxide-based catalyst or any combination thereof.

Examples of known catalysts: Cs—Ru/MgO and Ru/AC (intermetallic alloy) or catalysts based on hydrides or nitrides or alternatively trimetallic compounds.

Example of hydrides: which is a combination of hydrogen and metal or metalloid, such as metals supported on alkali metal hydrides and BaTiOxHy or Perovskite oxynitride-hydride catalysts (Ru/BaCeO3-xNyHz).

Example of nitrides that have high activity at low temperature and pressure, especially the Ni/LaN7 and LaN promoted Ru/ZrH2.

Preferably the catalyst is a promoted metal catalyst on a reducible or partially reducible mixed oxide support material.

The support material may be selected from Mg. Ce, La and any combination thereof.

A major advantage of the promoted metal catalyst on a reducible mixed oxide support material is that it has increased tolerance to impurities such as O₂ or H₂O in the feedstock gas. The decreased requirement for feedstock purification allows for a more compact system design. The catalyst is also less influenced by oxidation and deactivation during process stop or ramp down, enabling faster restoration of performance during process ramp up, which is of major importance for a small compact system design suitable for use with an intermittent energy source.

Example of suppliers of ammonia synthesis reactors and technology: Siemens Green Ammonia, Starfire Energy, Solar Hydrogen System, Iowa.

### Ammonia Separation Reactor 7

In the classical Haber Bosch process, the NH3 is removed from the un-reacted feedstock (N2 and H2) by means of NH3 condensation which is not suitable for a compact system of less that about 10 m3. The present energy production system uses solid absorbers for separation of NH3 from the unreacted feedstock both in the separator 7 and in the ammonia storage unit 8. The separation reactor 7 may also be an integrated part of the storage unit 8 which is an advantage for a compact system and for lowering of the production costs.

The selective solid absorber may contain an ammonia separation material such as metal halides, e.g., calcium chloride, operating at near synthesis temperatures. With this reaction and absorption process, ammonia can be synthesized at 15-30 bar, with rates comparable to the conventional process running at 100-300 bar. In reaction-absorption process, the rate of ammonia synthesis is controlled not by the chemical reaction but more by the pump used to recycle the unreacted gases. The absorbent material is capable of capturing NH3 from a gas stream at above ambient conditions, even when it is present in only small amounts.

Ammonia separation material may be a metal halide.

A metal halide of the ammonia separation reactor may have the general formula MaXz, wherein M is a cation selected from Mn and Mg, X is an anion selected from chloride and bromide, a is the number of cations per salt molecule, z is the number of anions per salt molecule.

The metal halide of the ammonia separation reactor may be supported by a substrate selected from alumina, silica or zeolite.

### Ammonia Storage Unit 8

Ammonia can be stored efficiently in a metal halide at theoretically the same volumetric density as liquid ammonia. Metal halides can also be used effectively to absorb the ammonia from the reactor where hydrogen and nitrogen is combined to produce ammonia.

Metal halide of the ammonia storage unit may have the general formula MaXz, wherein M is a cation selected from Mn and Mg, X is an anion selected from chloride and bromide, a is the number of cations per salt molecule, z is the number of anions per salt molecule.

The ammonia storage unit 8 may comprise the ammonia separation reactor 7.

Ammonia may be separated and stored in metal halides. An example of separation and storage of ammonia in metal halides is disclosed in Kale et al., ACS Appl. Energy Mater., Feb. 7, 2020, vo. 3, no. 3, pp. 2576-2584.

Ammonia is released from the absorbent by heating.

### Control System

A method of operating the energy production system comprising a central system controller, the method comprising:
a. receiving at the central system controller that a current power production is either above or below a power production threshold; and
b. transmitting a signal from the central system controller to cause the energy production system to switch to energy storage mode in which the reversible electrochemical cell system operates in electrolysis mode in the event that the power production rate is above the power production threshold; or to cause the energy production system to switch to an energy production mode in which the reversible electrochemical cell system operates in fuel-cell mode in the event that the power production is below the power production threshold.

| No. | Reference signs |
|---|---|
| 1 | Energy production system |
| 2 | Reversible electrochemical cell system |
| 3 | Air separator |
| 4 | Hydrogen (H2) separation and pressurization |
| 5 | Mixer |
| 6 | Ammonia (NH3) synthesis reactor |
| 7 | NH3 separator |
| 8 | NH3 storage |
| 9 | Steam generator |
| 10 | Water tank |
| 11 | Solar PV |
| 12 | Battery |
| 13 | Hot water tank |
| 14 | Blower |
| 15 | Compressor/pump |
| 16 a), b), | Heat exchanger |
| c), d), e), | |
| f), g) | |
| 17 | Household electricity need |
| 18 | Water based heating system |
| 19 a), b) | Air inlet |
| c) | |
| 19d | Nitrogen enriched air outlet |
| 20 a), b), | Oxygen, O2 outlet |
| c) | |

1. An energy production system (1) utilising ammonia for storage and production of electric power, said system comprising:
a reversible electrochemical cell system (2) adapted for production of hydrogen from electric power in an electrolysis mode when the energy production system (1) runs in electric power storage mode and production of electric power from ammonia in fuel-cell mode when the production system runs in electric power production mode;
an air separator (3) adapted to achieve at least 96% pure N₂, wherein the air separator is arranged to provide N₂ to the ammonia synthesis reactor (6) when the energy production system (1) runs in electric power storage mode;
an ammonia synthesis reactor (6) comprising a catalyst, wherein the synthesis reactor is arranged to receive H₂ from the reversible electrochemical cell system (2) and N₂ from the air separator (3) when the energy production system (1) runs in electric power storage mode;
an ammonia separation reactor (7) comprising a solid absorbent material which separates ammonia from N₂ and H₂ and adapted for receiving ammonia, and unreacted N₂ and H₂ from the ammonia synthesis reactor (6) and providing ammonia to an ammonia storage unit (8) when the energy production system (1) runs in electric power storage mode and;
an ammonia storage unit (8) comprising a metal halide adapted to store ammonia wherein the ammonia storage unit is arranged to receive ammonia from the ammonia synthesis reactor (6) and/or the ammonia separation reactor (7) when the energy production system (1) runs in electric power storage mode and arranged to provide ammonia to the reversible electrochemical cell system (2) when the energy production system (1) runs in electric power production mode;
a heat transfer system comprising at least one heat exchanger (16 a, b, c, d, e, f, g) adapted to transfer heat generated in the energy production system (1).

2. An energy production system (1), utilising ammonia for storage of electrical power and hydrogen for production of electric power wherein:
a reversible electrochemical cell system (2) adapted for production of hydrogen from electric power in an electrolysis mode when the energy production system (1) runs in electric power storage mode and production of electric power from hydrogen in fuel-cell mode when the production system runs in electric power production mode;
an air separator (3) adapted to achieve at least 96% pure N₂, wherein the air separator is arranged to provide N₂ to the ammonia synthesis reactor (6) when the energy production system (1) runs in electric power storage mode;
an ammonia synthesis-and ammonia cracker reactor comprising a catalyst, wherein the synthesis reactor is arranged to receive H₂ from the reversible electrochemical cell system (2) and N₂ from the air separator (3) when the energy production system (1) runs in electric power storage mode and wherein the ammonia cracker decompose the ammonia into N₂ and H₂ in electric power production mode thereby providing a H₂ gas stream to the reversible electrochemical cell system (2),
an ammonia separation reactor (7) comprising a solid absorbent material which separates ammonia from N₂ and H₂ and adapted for receiving ammonia, and unreacted N₂ and H₂ from the ammonia synthesis-and ammonia cracker reactor and providing ammonia to the ammonia storage unit (8) when the energy production system (1) runs in electric power storage mode and;
an ammonia storage unit (8) comprising a metal halide adapted to store ammonia wherein the ammonia storage unit is arranged to receive ammonia from the ammonia synthesis-and ammonia cracker reactor and/or an ammonia separation reactor (7) when the energy production system (1) runs in electric power storage mode and arranged to provide ammonia to the ammonia synthesis-and ammonia cracker reactor when the energy production system (1) runs in electric power production mode;
a heat transfer system comprising at least one heat exchanger (16 a, b, c, d, e, f, g) adapted to transfer heat generated in the energy production system (1).

3. The energy production system according to claim 1, wherein the reversible electrochemical cell system operates in a temperature range from 400° C. to 800° C.

4. The energy production system according to claim 2, wherein the reversible electrochemical cell system is adapted to tolerate impurities in the H₂ gas stream provided from the ammonia cracker when the system runs in electric power production mode.

5. The energy production system according to claim 4, wherein the reversible electrochemical cell system is adapted to tolerate at least 0.15% ammonia in the H₂ gas stream such as from 0.05% to 1% ammonia.

6. The energy production system according to claim 1, wherein the reversible electrochemical cell system is connected to or comprises a reactor (4) for H₂ separation and compression and arranged to provide H₂ to the ammonia synthesis reactor, wherein the energy production system is adapted for production of ammonia in electric power storage mode.

7. The energy production system according to claim 1, wherein the ammonia synthesis reactor is adapted to operate at a temperature in the range from 250° C. to 500° C.

8. The energy production system according to claim 1, wherein the ammonia synthesis reactor is adapted to operate at pressure of 3 MPa or lower.

9. The energy production system according to claim 1, wherein the catalyst comprises an Fe-based catalyst, an Ru-based catalyst, a ceramic mixed oxide-based catalyst, or a promoted metal catalyst on a reducible or partially reducible mixed oxide support material.

10. The energy production system according to claim 1, wherein the catalyst is a promoted metal catalyst on a reducible or partially reducible mixed oxide support material.

11. The energy production system according to claim 10, wherein the support material is selected from Mg, Ce, La, and a combination thereof.

12. The energy production system according to claim 1, wherein the ammonia synthesis reactor is adapted to operate at a pressure-times (*)-volume of about 3 MPa*litre or lower.

13. The energy production system according to claim 1, wherein the ammonia storage unit is connected to or comprises at least one ammonia separation reactor comprising an ammonia separation material.

14. The energy production system according to claim 11, wherein the ammonia separation material of the ammonia separation reactor is a metal halide.

15. The energy production system according to claim 1, wherein the system includes a recirculation pump that is adapted to pump unreacted H₂ and N₂ and unabsorbed NH₃ back into the ammonia synthesis reactor from the ammonia separator.

16. The energy production system according to claim 1, wherein the system comprises a central system controller and a sensor wherein the central system controller is adapted to receiving that a current power production is either above or below a power production threshold; and transmitting a signal from the central system controller to cause the energy production system to switch to energy storage mode in which the reversible electrochemical cell system operates in electrolysis mode in the event that the power production rate is above the power production threshold; or to cause the energy production system to switch to an energy production mode in which the reversible electrochemical cell system operates in fuel-cell mode in the event that the power production is below the power production threshold.

17. The energy production system according to claim 1, wherein the heat transfer system comprising at least one heat exchanger adapted to transfer heat generated by one or more of a unit of the energy production system in order to capture and provide heat to a water-based heating system in a household or a small commercial building.

18. The energy production system according to claim 1, wherein the heat transfer system comprising at least one heat exchangers adapted to transfer heat between at least two separate units of the energy production system.

19. The energy production system according to claim 1, wherein the reversible electrochemical cell system is connected to a heat exchanger in order to capture and provide heat to a water-based heating system in a household or a small commercial building.

20. The energy production system according to claim 1, wherein the system comprises or is connected to an intermittent energy resource.

21. The energy production system according to claim 20, wherein the intermittent energy resource is selected from—a solar PV module, a wind turbine, a water turbine, and combinations thereof.

22. The energy production system according to claim 1, wherein the system is a compact system having dimensions of less than 10 cubic meter.

23. (canceled)

24. (canceled)

25. A method of operating the energy production system according to claim 1, wherein the system further comprises a central system controller, the method comprising:
a. receiving at the central system controller that a current power production is either above or below a power production threshold; and
b. transmitting a signal from the central system controller to cause the energy production system to switch to energy storage mode in which the reversible electrochemical cell system operates in electrolysis mode in the event that the power production rate is above the power production threshold; or to cause the energy production system to switch to an energy production mode in which the reversible electrochemical cell system operates in fuel-cell mode in the event that the power production is below the power production threshold.
